(19) United States
(12) Patent Application Publication
(10) Pub. No.: US 2019/0295410 A1
(43) Pub. Date: Sep. 26, 2019

(54) INFORMATION PROCESSING METHOD AND INFORMATION PROCESSING DEVICE

(71) Applicant: TOYOTA JIDOSHA KABUSHIKI KAISHA, Toyota-shi (JP)

(72) Inventor: Yu NAGATA, Yashio-shi (JP)

(73) Assignee: TOYOTA JIDOSHA KABUSHIKI KAISHA, Toyota-shi (JP)

(21) Appl. No.: 16/293,989

(22) Filed: Mar. 6, 2019

(30) Foreign Application Priority Data
Mar. 22, 2018 (JP) 2018-055122

(51) Int. Cl. G08G 1/01; B60W 50/14

(52) U.S. Cl. CPC G08G 1/0145; G08G 1/0129; B60W 2550/40; B60W 2050/143; B60W 2550/22; B60W 50/14

(57) ABSTRACT

A first acquisition unit of an information processing device acquires a condition that is likely to cause a traffic violation, the condition being derived for a relevant site where a traffic violation occurred in the past. A notification unit communicates alert information before the relevant site is arrived at, when a traveling situation and/or a driver of a vehicle traveling toward the relevant site meets the condition that is likely to cause a traffic violation, the condition being acquired by the first acquisition unit.

The disclosure of Japanese Patent Application No. 2018-055122 filed on Mar. 22, 2018 including the specification, drawings and abstract is incorporated herein by reference in its entirety.

### BACKGROUND

### 1. Technical Field

The disclosure relates to an information processing method and an information processing device for processing information acquired from a vehicle.

### 2. Description of Related Art

JP2016-71492 discloses a system in which vehicle information transmitted from a vehicle is compared with vehicle information collected for accidents and mishaps that occurred in the past, a common denominator is identified, an estimation is made based on the common denominator to see whether an environment is a factor that caused an accident etc. involving the vehicle, any environmental factor that caused an accident or the like is reflected in map information, and the driver is notified of a site where an accident is relatively likely to occur.

According to the technology of JP2016-71492, it is impossible to indicate a site where traffic violation such as reverse run on an expressway or ignoring of a traffic light has occurred frequently.

### SUMMARY

The embodiments address the above-described issues, and a general purpose thereof is to provide an information processing method and an information processing device capable of communicating alert information to a vehicle that is likely to cause a traffic violation.

An information processing method according to an embodiment includes: acquiring a condition that is likely to cause a traffic violation, the condition being derived for a relevant site where a traffic violation occurred in the past; and communicating alert information before the relevant site is arrived at, when a traveling situation and/or a driver of a vehicle traveling toward the relevant site meets the condition that is likely to cause a traffic violation.

According to this embodiment, the alert information is communicated when the traveling situation and/or the driver of the vehicle traveling toward the relevant site where a traffic violation occurred in the past meets a condition that is likely to cause a traffic violation, derived for the relevant site. Therefore, the alert information is communicated to the vehicle that is likely to cause a traffic violation.

The acquiring may include acquiring the condition that is likely to cause a traffic violation when the vehicle is traveling toward the relevant site.

The information processing method may further include: acquiring vehicle information on a plurality of vehicles that have caused a traffic violation, driver information on the plurality of vehicles, and information on a surrounding environment of the plurality of vehicles; deriving sites and conditions in which the plurality of vehicles caused a traffic violation, based on the information acquired in the acquiring of information; and extracting, from a plurality of sites and conditions derived in the deriving, the relevant site and the condition that is likely to cause a traffic violation.

The condition that is likely to cause a traffic violation may include at least one of a route traveled by the vehicle before the relevant site, a speed of the vehicle at the relevant site, a weather at the relevant site, a time zone in which the vehicle traveled at the relevant site, a history of driving by the driver, an age of the driver, a place of birth of the driver, and the number of times that the driver traveled at the relevant site.

Another embodiment relates to an information processing device. The device includes: a first acquisition unit configured to acquire a condition that is likely to cause a traffic violation, the condition being derived for a relevant site where a traffic violation occurred in the past; and a notification unit configured to communicate alert information before the relevant site is arrived at, when a traveling situation and/or a driver of a vehicle traveling toward the relevant site meets the condition that is likely to cause a traffic violation, the condition being acquired by the first acquisition unit.

According to this embodiment, the alert information is communicated when the traveling situation and/or the driver of the vehicle traveling toward a site where a traffic violation occurred in the past meets a condition that is likely to cause a traffic violation, derived for the relevant site. Therefore, the alert information is communicated to the vehicle that is likely to cause a traffic violation.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a block diagram of a vehicle system according to an embodiment;

FIG. 2 is a block diagram showing a configuration of the vehicle-mounted device of FIG. 1;

FIG. 3 is a block diagram showing a configuration of the server device of FIG. 1;

FIG. 4 shows an example of traffic violation of reverse run on the road at an interchange of an expressway;

FIG. 5 shows examples of violation condition and violation percentage for a traffic violation of reverse run at the violation site of FIG. 4;

FIG. 6 shows how the vehicle entering the interchange of FIG. 4 is alerted;

FIG. 7 is a flowchart showing a process performed in the server device of extracting a condition that is likely to cause a traffic violation; and

FIG. 8 is a flowchart showing a process performed by the server device of FIG. 1 of communicating alert information.

### DETAILED DESCRIPTION

Various embodiments now will be described. The embodiments are illustrative and are not intended to be limiting.

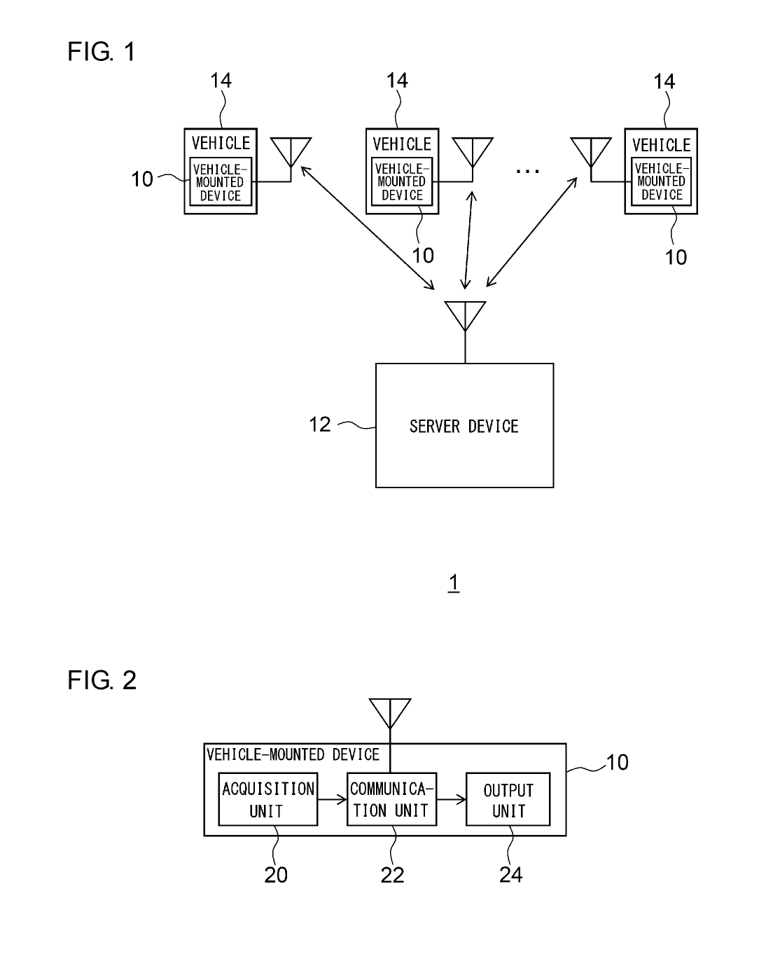

FIG. 1 is a block diagram of a vehicle system 1 according to an embodiment. The vehicle system 1 includes a plurality of vehicle-mounted devices 10 and a server device 12. FIG. 1 shows three vehicle-mounted devices 10 of the plurality of vehicle-mounted devices 10.

The vehicle-mounted device 10 is carried on a vehicle 14 that is an automobile. The vehicle-mounted device 10 communicates wirelessly with the server device 12. The embodiment is non-limiting as to the standard for wireless communication. For example, 3G (third-generation mobile communication system), 4G (fourth-generation mobile communication system), or 5G (fifth-generation mobile communication system) is covered. The vehicle-mounted device 10 may communicate wirelessly with the server device 12 via a base station (not shown). The server device 12 is installed at, for example, a data center and functions as an information processing device that processes big data transmitted from the plurality of vehicle-mounted devices 10.

FIG. 2 is a block diagram showing a configuration of the vehicle-mounted device 10 of FIG. 1. The vehicle-mounted device 10 includes an acquisition unit 20, a communication unit 22, and an output unit 24. The acquisition unit 20 periodically acquires vehicle information on the driver's vehicle and information on environment surrounding the driver's vehicle (hereinafter, referred to as surrounding environment information) and outputs the vehicle information and the surrounding environment information to the communication unit 22. For example, the vehicle information includes positional information on the driver's vehicle, orientation information indicating the direction of travel of the driver's vehicle, speed information on the driver's vehicle, route guidance information of a navigation system. For example, the position information is acquired from a GPS receiver (not shown) of the driver's vehicle. For example, the orientation information and the speed information are acquired from various sensors (not shown) of the driver's vehicle. The route guidance information is acquired from a navigation system (not shown) of the driver's vehicle.

The surrounding environment information includes traffic light information indicating whether a traffic light ahead of the driver's vehicle is red. The traffic light information is derived from an image of a traffic light ahead of the driver's vehicle captured by a camera of, for example, a drive recorder (not shown) of the driver's vehicle. The image of a traffic light is captured before the position of the traffic light identified from map information.

The frequency of acquiring vehicle information may be defined as appropriate through, for example, experiments. For example, the information may be acquired several to several tens of times per one second. The frequency of acquiring vehicle information may vary depending on the type of vehicle information. The time of acquisition may be attached to the vehicle information and the surrounding environment information. Alternatively, the time when the server device 12 receives the vehicle information and the surrounding environment information may be regarded as the time of acquisition.

The communication unit 22 communicates wirelessly with the server device 12. The communication unit 22 periodically transmits the vehicle information and the surrounding environment information acquired by the acquisition unit 20 to the server device 12. Information identifying the transmitting vehicle 14 is attached to the vehicle information and the surrounding environment information. The frequency of transmitting the information may be defined as appropriate through, for example, experiments. For example, the frequency may be equal to the frequency at which the acquisition unit 20 acquires the vehicle information.

When the server device 12 transmits alert information to the driver's vehicle, the communication unit 22 receives the alert information. The output unit 24 outputs the alert information received by the communication unit 22 to the driver. The details of the output unit 24 will be described later.

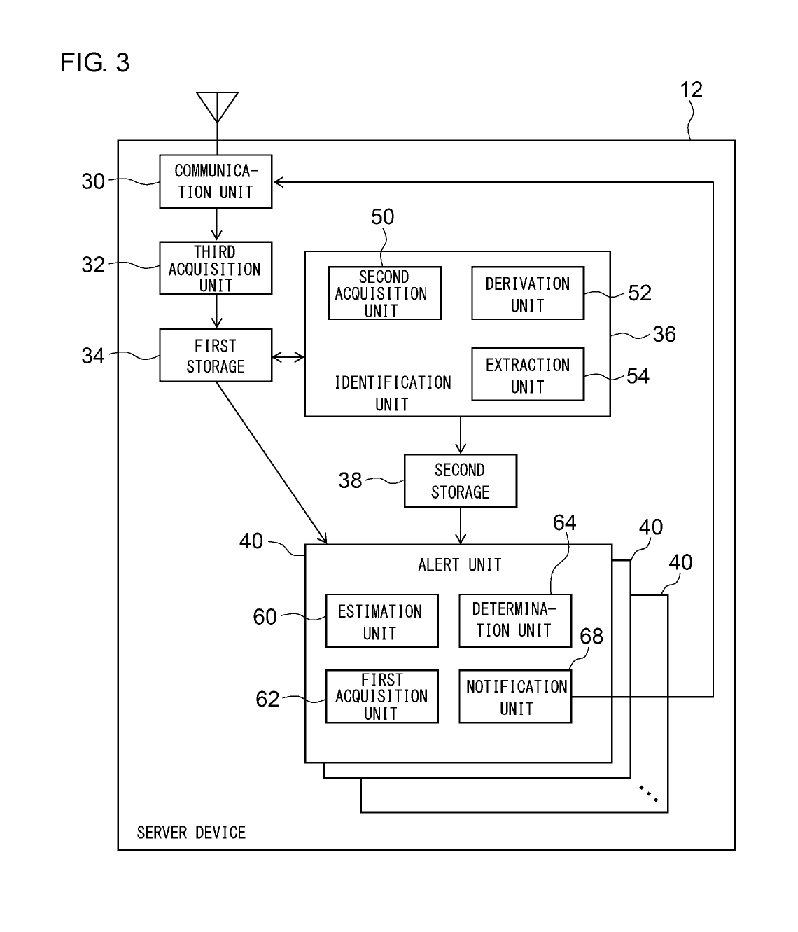

FIG. 3 is a block diagram showing a configuration of the server device 12 of FIG. 1. The server device 12 includes a communication unit 30, a third acquisition unit 32, a first storage 34, an identification unit 36, a second storage 38, and a plurality of alert units 40.

The communication unit 30 communicates wirelessly with the communication units 22 of the plurality of vehicle-mounted devices 10. The communication unit 30 receives the vehicle information and the surrounding environment information on a plurality of vehicles 14 from the communication units 22 of the plurality of vehicle-mounted devices 10.

The third acquisition unit 32 acquires the vehicle information and the surrounding environment information on the plurality of vehicles 14 received by the communication unit 30. Further, the third acquisition unit 32 acquires information on the weather near the position of each vehicle 14 and occurring at the time corresponding to that position via the Internet or the like. The information on the weather is also the surrounding environment information on the vehicle 14. The third acquisition unit 32 outputs the vehicle information and the surrounding environment information on the plurality of vehicles 14 to the first storage 34. The first storage 34 stores the vehicle information and the surrounding environment information on the plurality of vehicles 14 acquired by the third acquisition unit 32.

The first storage 34 stores driver information on the plurality of vehicles 14. The driver information includes a history of driving, age, and a place of birth of the driver, and the number of times that the driver traveled at the site where the driver caused a traffic violation. The history of driving, age, and place of birth are entered by the driver or an operator in advance. As described later, the number of times that the driver traveled at the site where the driver caused a traffic violation is stored when the host vehicle 14 caused a traffic violation. In the case the host vehicle 14 has not caused a traffic violation, the number of times that the driver traveled at the site where the driver caused a traffic violation is not stored. Information for identifying the vehicle 14 is attached to the driver information.

The identification unit 36 identifies a plurality of combinations each including a relevant site where a traffic violation occurred in the past and a condition that is likely to cause a traffic violation at the relevant site, based on the vehicle information, the driver information, and the surrounding environment information on the plurality of vehicles 14. The identification unit 36 includes a second acquisition unit 50, a derivation unit 52, and an extraction unit 54.

The second acquisition unit 50 acquires the vehicle information, the driver information, and the surrounding environment information on the plurality of vehicles 14 from the first storage 34. The plurality of vehicles 14 include a plurality of vehicles 14 that have caused a traffic violation.

The derivation unit 52 identifies the plurality of vehicles 14 that have caused a traffic violation based on the information acquired by the second acquisition unit 50, periodically derives sites and conditions in which the vehicles 14 caused a traffic violation, and outputs the derived information to the extraction unit 54. The frequency of deriving these items of information may be defined as appropriate through, for example, experiments. The site where the vehicle 14 caused a traffic violation will be referred to as a violation site, and the condition in which the vehicle 14 caused a traffic violation will be referred to as a violation condition.

For example, traffic violation encompasses reverse run on a road, excessive speed, stop sign violation, and ignoring of a traffic light. At each position of the vehicle 14, the derivation unit 52 determines whether the angle formed by the traveling direction of the road acquired from the map information and the direction of travel based on the orientation information on the vehicle 14 is equal to or greater than a first threshold value. When the angle is equal to or greater than the first threshold value, the derivation unit 52 identifies that the vehicle 14 has caused a traffic violation of reverse run on the road. The first threshold value can be defined as appropriate through, for example, experiments to enable identifying a case of reverse run.

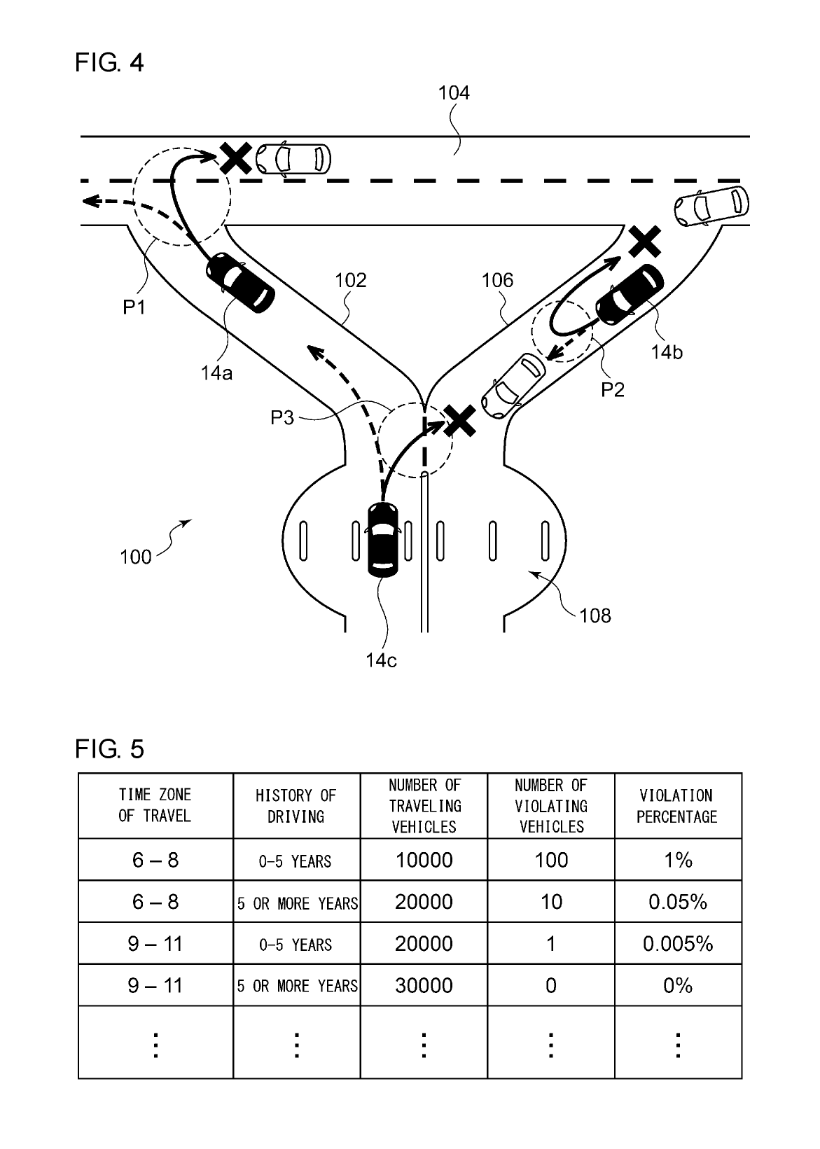

FIG. 4 shows an example of traffic violation of reverse run on the road at an interchange 100 of an expressway. For example, a vehicle 14a traveling toward the main road 104 of the expressway via an entrance ramp 102 of the interchange 100 is traveling reversely at a violation site P1 because, for example, the driver has overlooked a traffic sign indicating the direction of travel. A vehicle 14b entering an exit ramp 106 from the main road 104 and traveling toward a tollgate 108 is intentionally driven reversely on the exit ramp 106 at a violation site P2 to return to the main road 104 because the drive noticed the wrong exit.

A vehicle 14c traveling past the tollgate 108 and traveling toward the entrance ramp 102 travels reversely on the exit ramp 106 at a violation site P3 because, for example, the driver has overlooked a traffic sign indicating the direction of travel. In the case there are a plurality of roads to enter the interchange 100, the visibility of a sign, etc. differs depending on the condition of the road traveled so that a vehicle entering the interchange 100 from a particular road may be more likely to travel reversely on the exit ramp 106 than vehicles entering from other roads. In other words, the probability of traffic violation may differ depending on the route traveled before the violation site.

Referring back to FIG. 3, the derivation unit 52 determines, at each position of the vehicle 14, whether the speed of the vehicle 14 is equal or higher than the legal speed of the road acquired from the map information by a second threshold value or larger. When the speed of the vehicle 14 is equal to or higher than the legal speed by the second threshold value or larger, the derivation unit 52 determines that the vehicle 14 has caused a traffic violation of excessive speed.

When the speed of the vehicle 14 passing a site where the vehicle is instructed to make a temporary stop acquired from the map information is equal or higher than a third threshold value, the derivation unit 52 identifies that the vehicle 14 has caused a traffic violation of stop sign violation. An instruction for temporary stop includes a stop sign or a stop line.

When the traffic light information acquired by the second acquisition unit 50 indicates a red light at a site of traffic light acquired from the map information, the derivation unit 52 determines that the vehicle 14 has caused a traffic violation of ignoring a traffic light, when the speed of the vehicle 14 passing the site is equal to higher than the third threshold value. The second threshold value and the third threshold value can be determined as appropriate through, for example, experiments.

When the driver information on the vehicle 14 that has caused a traffic violation does not include the number of times that the driver traveled at the violation site, the derivation unit 52 sets the number of times of travel at the violation site to “1” and causes the first storage 34 to store the number. When the driver information on the vehicle 14 that caused a traffic violation includes the number of times of travel at the violation site, the derivation unit 52 increments the number of times of traveling at the violation site by “1” and causes the first storage 34 to store the number.

In association with the violation site of each vehicle 14, the derivation unit 52 derives a violation condition that includes the route traveled by the vehicle 14 before the violation site, the speed of the vehicle 14 at the violation site, the weather at the violation site, the time zone of travel at the violation site, the history of driving by the driver, the age of the driver, the place of birth of the driver, and the number of times that the driver traveled at the violation site.

The extraction unit 54 refers to a plurality of violation sites and violation conditions derived by the derivation unit 52 and extracts a plurality of combinations each including a relevant site where a traffic violation occurred in the past and a condition that is likely to cause a traffic violation at the relevant site. The extraction unit 54 extracts a plurality of violation sites that can be regarded as a single site as the same relevant site. For example, violation sites within a radius of several meters can be regarded as the same site.

The extraction unit 54 derives, for each violation condition, a percentage (violation percentage) of the number of violating vehicles with respect to the number of traveling vehicles that meet the violation condition at the relevant site. The extraction unit 54 extracts the violation condition for which the violation percentage is equal to or higher than an extraction threshold value as a condition that is likely to cause a traffic violation. The extraction threshold value can be defined as appropriate in accordance with the violation percentage actually derived. The extraction threshold value may be defined for each type of traffic violation. Information on a type of traffic violation is attached to a condition that is likely to cause a traffic violation.

For example, the condition that is likely to cause a traffic violation includes at least one of the route traveled by the vehicle 14 before the relevant site, the speed of the vehicle 14 at the relevant site, the weather at the relevant site, the time zone of travel at the relevant site, the history of driving by the driver, the age of the driver, the place of birth of the driver, and the number of times that the driver traveled at the relevant site. For example, inclusion of a traveling route can address a situation where a particular traffic violation is likely to be caused when the vehicle travels toward the relevant site on a particular traveling route. Inclusion of the place of birth of the driver can address a situation where a particular traffic violation is likely to be caused when the place of birth of the driver is a particular area. Inclusion of the number of times that the driver traveled at the relevant site can address a situation where the smaller the number of times of travel, the more a particular traffic violation is likely to be caused.

FIG. 5 shows examples of violation condition and violation percentage for a traffic violation of reverse run at the violation site P3 of FIG. 4. For clarity, FIG. 5 shows the time zone of travel, the history of driving, the number of traveling vehicles, the number of violating vehicles, and the violation percentage, but the traveling route, the speed, the weather, the age of the driver, the place of birth of the driver, and the number of times that the drive traveled at the relevant site can also be included.

In this example, each time zone of travel is defined to span three hours. The history of driving is organized into a group of less than five years and a group of five years or longer. When the time zone of travel is between six o'clock and nine o'clock and the history of driving by the driver is less than five years, the number of traveling vehicles is 10,000, the number of violating vehicles is 100, and the violation percentage is 1%. When the time zone of travel is between six o'clock and nine o'clock and the history of driving by the driver is five years or longer, the number of traveling vehicles is 20,000, the number of violating vehicles is 10, and the violation percentage is 0.05%.

When the extraction threshold value is set to 0.5%, for example, the extraction unit 54 extracts “the time zone of travel is between six o'clock and nine o'clock and the history of driving by the driver is less than five years” as a condition that is likely to cause a traffic violation. When the extraction threshold value is set to 0.05%, for example, the extraction unit 54 extracts “the time zone of travel is between six o'clock and nine o'clock” as a condition that is likely to cause a traffic violation. The extraction unit 54 extracts the violation site P3 as the relevant site.

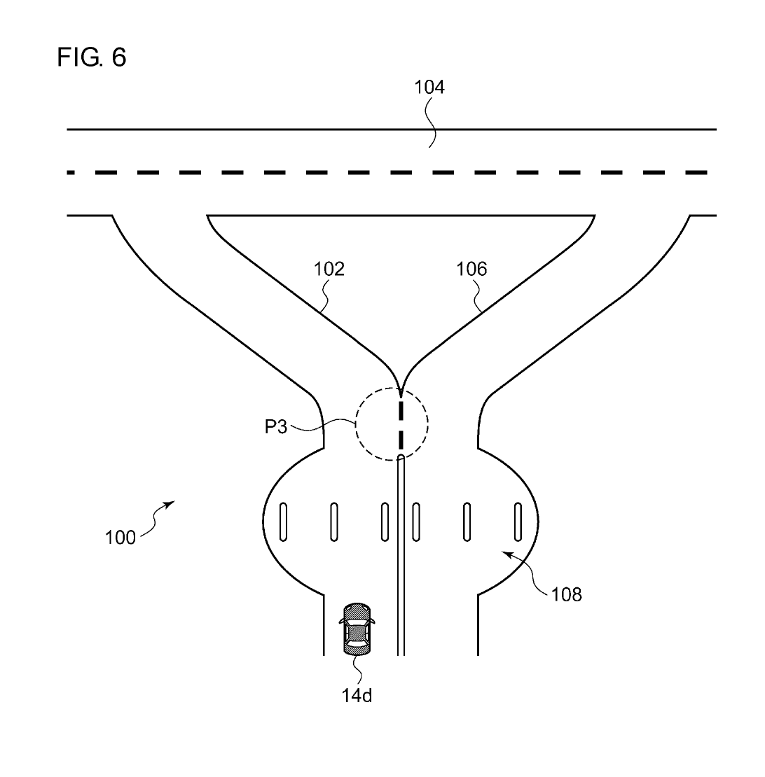

Referring back to FIG. 3, each of the plurality of alert units 40 determines whether to alert the driver of the associated vehicle 14. The plurality of alert units 40 have the same function except that the units are associated with different vehicles 14. A description will therefore be given of the alert unit 40 associated with a vehicle 14d of FIG. 6, with reference to FIG. 6 as well as FIG. 3.

FIG. 6 shows how the vehicle 14d entering the interchange 100 of FIG. 4 is alerted. The vehicle 14d is traveling toward the tollgate 108.

The alert unit 40 includes an estimation unit 60, a first acquisition unit 62, a determination unit 64, and a notification unit 68. The estimation unit 60 acquires the current position information and the route guidance information on the associated vehicle 14d from the first storage 34. The estimation unit 60 estimates whether the vehicle 14d is traveling toward any of the relevant sites stored in the second storage 38 where a traffic violation occurred in the past, based on the map information, the position information, and the route guidance information. The estimation unit 60 estimates that the vehicle 14d is traveling toward the relevant site P3 in the case the route of the route guidance information passes through the relevant site P3 and the distance from the current position of the vehicle 14d to the relevant site P3 is equal to or smaller than a fourth threshold value. In the case the route guidance information is not stored in the first storage 34, the estimation unit 60 estimates that the vehicle 14d is traveling toward the relevant site P3 when the relevant site P3 is located in the direction of travel of the vehicle 14d and the distance from the current position of the vehicle 14d to the relevant site P3 is equal to or smaller than a fourth threshold value. The fourth threshold value may be defined as appropriate through, for example, experiments. For example, the fourth threshold value may be between several tens of meters and several hundreds of meters. The fourth threshold value may differ from one relevant site to another. The estimation unit 60 outputs the relevant site P3, toward which the vehicle 14d is traveling, to the first acquisition unit 62.

In the case the vehicle 14d is traveling toward the relevant site P3, the first acquisition unit 62 acquires a condition that is likely to cause a traffic violation at the relevant site P3 from the second storage 38 and acquires the current vehicle information, driver information, and surrounding environment information on the vehicle 14d from the first storage 34. The first acquisition unit 62 outputs the acquired information to the determination unit 64.

The determination unit 64 determines whether the traveling situation and/or the driver of the vehicle 14d traveling toward the relevant site P3 meets the condition that is likely to cause a traffic violation, based on the condition that is likely to cause a traffic violation and the vehicle information/driver information/surrounding environment information on the vehicle 14d output from the first acquisition unit 62. The traveling situation includes the traveling route as far as the current position, speed, weather, and time zone of travel. The determination unit 64 outputs a result of determination to the notification unit 68.

When the traveling situation and/or the driver of the vehicle 14d traveling toward the relevant site P3 is found to meet the condition that is likely to cause a traffic violation based on the result of determination by the determination unit 64, the notification unit 68 communicates alert information to the vehicle 14d via the communication unit 30 before the vehicle 14d arrives at the relevant site P3. When the traveling situation and/or the driver of the vehicle 14d traveling toward the relevant site P3 does not meet the condition that is likely to cause a traffic violation, the notification unit 68 does not communicate alert information.

The notification unit 68 generates alert information in accordance with the type of traffic violation and the condition that is likely to cause a traffic violation. The alert information is character information including a type of traffic violation. The alert information may include the condition that is likely to cause a traffic violation. In the example of FIG. 6, the alert information will be character information that says “There have been a lot of reverse run cases immediately inside the entrance in this time zone. Please drive by watching the traffic sign carefully”. To describe the method of notification more specifically, the notification unit 68 outputs the alert information to the communication unit 30. The communication unit 30 transmits the alert information to the vehicle 14d. Information for identifying the vehicle 14d that is the destination of transmission is attached to the alert information.

Referring back to FIG. 2, the communication unit 22 of the vehicle-mounted device 10 of the vehicle 14d receives the alert information transmitted from the communication unit 30 of the server device 12. The communication unit 30 supplies the alert information to the output unit 24. The output unit 24 outputs the alert information supplied from the communication unit 22 to the driver before the vehicle 14d arrives at the relevant site. The output unit 24 may be configured as a display adapted to display the alert information as characters, images, etc. Alternatively, the output unit 24 may be configured as a speaker adapted to output the alert information as sound. Still alternatively, the output unit 24 may be configured as a combination of these. It is preferred that the output unit 24 output the alert information in the form of sound so that the driver can notice the alert information easily. The display may be configured as a head-up display for projecting the alert information to the front window of the vehicle 14d.

The identification unit 36 and the alert unit 40 of the server device 12 are implemented in hardware such as a CPU, a memory, or other LSI's of an arbitrary computer, and in software such as a program loaded into a memory, etc. The figure depicts functional blocks implemented by the cooperation of these elements. Therefore, it will be understood by those skilled in the art that the functional blocks may be implemented in a variety of manners by hardware only, software only, or by a combination of hardware and software.

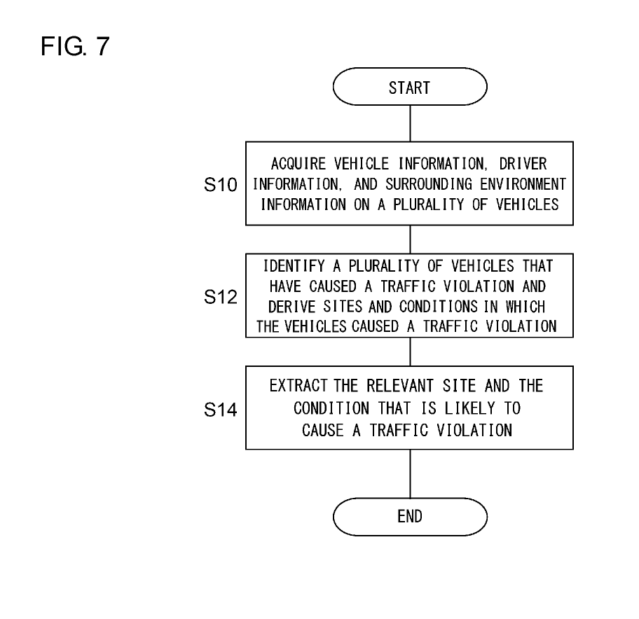

A description will now be given of an overall operation of the vehicle system 1 having the above configuration. FIG. 7 is a flowchart showing a process performed by the server device 12 of FIG. 1 of extracting a condition that is likely to cause a traffic violation. The process of FIG. 7 is performed periodically. The second acquisition unit 50 acquires the vehicle information, the driver information, and the surrounding environment information on a plurality of vehicles 14 (S10). The derivation unit 52 identifies a plurality of vehicles 14 that have caused a traffic violation and derives sites and conditions in which the vehicles 14 caused a traffic violation (S12). The extraction unit 54 extracts the relevant site and the condition that is likely to cause a traffic violation (S14).

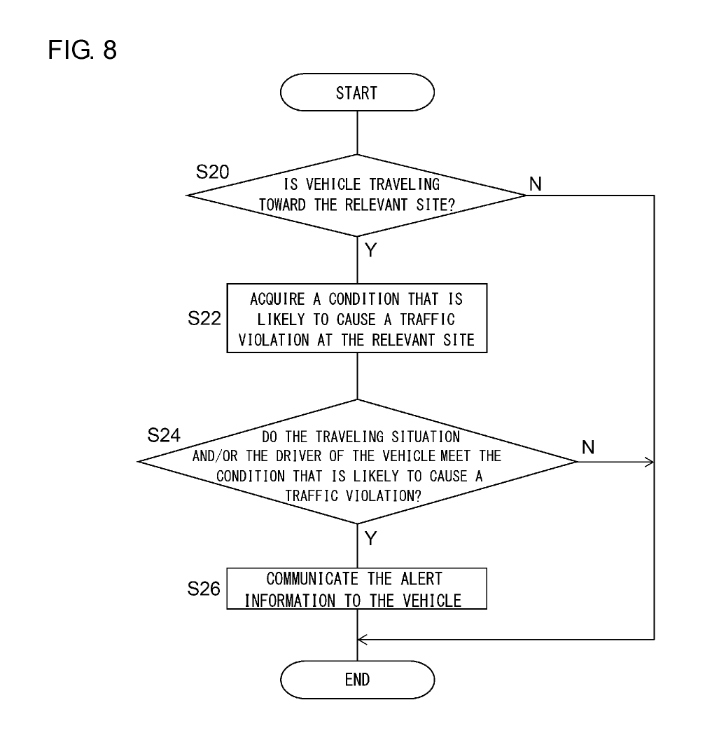

FIG. 8 is a flowchart showing a process performed by the server device 12 of FIG. 1 of communicating alert information. The process of FIG. 8 is periodically performed in each of the plurality of alert units 40. When the associated vehicle 14 is traveling toward the relevant site (Y in S20), the first acquisition unit 62 acquires a condition that is likely to cause a traffic violation at the relevant site (S22). When the traveling situation and/or the driver of the vehicle 14 meets the condition that is likely to cause a traffic violation (Y in S24), the notification unit 68 communicates the alert information to the vehicle 14 (S26) and terminates the process. When the vehicle 14 is not found to be traveling toward the relevant site in step S20 (N in S20), the process is terminated. When the traveling situation and/or the driver of the vehicle 14 does not meet the condition that is likely to cause a traffic violation in step S24 (N in S24), the process is terminated.

According to the embodiment, the alert information is communicated when the traveling situation and/or the driver of the vehicle 14 traveling toward the relevant site where a traffic violation occurred in the past meets a condition that is likely to cause a traffic violation, derived for the relevant site. Therefore, the alert information is selectively communicated to the vehicle 14 that is likely to cause a traffic violation before a traffic violation is caused. The alert information is not communicated to the vehicle 14 that is less likely to cause a traffic violation. Therefore, the driver of the vehicle 14 feels less of a hassle of receiving the notification so that the usefulness of the alert information communicated is increased.

Further, a condition that is likely to cause a traffic violation at a relevant site is acquired when the vehicle 14 is traveling toward the relevant site. Therefore, a necessary condition is acquired at a necessary point of time.

Further, sites and conditions in which a plurality of vehicles 14 have caused a traffic violation are derived based on information on those vehicles 14 that have caused a traffic violation, and a relevant site where a traffic violation occurred in the past and a condition that is likely to cause a traffic violation are extracted from the plurality of sites and conditions thus derived. Therefore, a condition that is likely to cause a traffic violation at the relevant site is identified highly precisely.

Described above is an explanation based on exemplary embodiments. The embodiments are intended to be illustrative only, and it will be obvious to those skilled in the art that various modifications to a combination of constituting elements or processes could be developed and that such modifications also fall within the scope of the present disclosure.

For example, even if the traveling situation and/or the driver of the vehicle 14 traveling toward a relevant site meets a condition that is likely to cause a traffic violation of excessive speed, stop sign violation, and ignoring of a traffic light, the alert information may not be communicated if the vehicle 14 has not caused any of these traffic violations during the travel of a predetermined distance or greater as far as the current position. This is because the vehicle 14 that has not caused a traffic violation is estimated to be a safely driven vehicle 14 that tends to observe traffic regulations. The predetermined distance may be defined as appropriate. This can inhibit unnecessary notifications to safely driven vehicle 14. It is preferred to communicate alert information related to reverse run because even a safely driven vehicle 14 might cause a traffic violation of reverse run on the road due to poor visibility of the sign.

In this embodiment, an example where the server device 12 is provided with a plurality of alert units 40 associated with a plurality of vehicles 14 has been described. Alternatively, the alert unit 40 may be provided in the vehicle-mounted device 10 of each vehicle 14. In this case, the vehicle-mounted device 10 acquires a condition that is likely to cause a traffic violation, derived for a relevant site, from the server device 12, and the alert information is communicated to the driver when the traveling situation and/or the driver of the driver's vehicle traveling toward the relevant site meets the condition that is likely to cause a traffic violation. The vehicle-mounted device 10 functions as an information processing device. In this variation, the flexibility of the configuration of the vehicle system 1 is improved.

The server device 12 may acquire traffic light information from another server device provided in, for example a traffic control center. In this case, the vehicle-mounted device 10 need not acquire traffic light information. In this variation, the configuration of the vehicle-mounted device 10 is simplified.

What is claimed is:

1. An information processing method comprising:
acquiring a condition that is likely to cause a traffic violation, the condition being derived for a relevant site where a traffic violation occurred in the past; and
communicating alert information before the relevant site is arrived at, when a traveling situation and/or a driver of a vehicle traveling toward the relevant site meets the condition that is likely to cause a traffic violation.

2. The information processing method according to claim 1, wherein
the acquiring includes acquiring the condition that is likely to cause a traffic violation when the vehicle is traveling toward the relevant site.

3. The information processing method according to claim 1, further comprising:
acquiring vehicle information on a plurality of vehicles that have caused a traffic violation, driver information on the plurality of vehicles, and information on a surrounding environment of the plurality of vehicles;
deriving sites and conditions in which the plurality of vehicles caused a traffic violation, based on the information acquired in the acquiring of information; and
extracting, from a plurality of sites and conditions derived in the deriving, the relevant site and the condition that is likely to cause a traffic violation.

4. The information processing method according to claim 1, wherein
the condition that is likely to cause a traffic violation includes at least one of a route traveled by the vehicle before the relevant site, a speed of the vehicle at the relevant site, a weather at the relevant site, a time zone in which the vehicle traveled at the relevant site, a history of driving by the driver, an age of the driver, a place of birth of the driver, and the number of times that the driver traveled at the relevant site.

5. An information processing device comprising:
a first acquisition unit configured to acquire a condition that is likely to cause a traffic violation, the condition being derived for a relevant site where a traffic violation occurred in the past; and
a notification unit configured to communicate alert information before the relevant site is arrived at, when a traveling situation and/or a driver of a vehicle traveling toward the relevant site meets the condition that is likely to cause a traffic violation, the condition being acquired by the first acquisition unit.
